(19) United States
(12) Patent Application Publication
(10) Pub. No.: US 2016/0195301 A1
(43) Pub. Date: Jul. 7, 2016

(54) Water Heater

(71) Applicant: WINSLIM, Luxembourg (LU)

(72) Inventor: Jean-Yves Gaspard, Gleize (FR)

(21) Appl. No.: 14/910,945

(22) PCT Filed: Jul. 31, 2014
(86) PCT No.: PCT/EP2014/066493

§ 371 Date: Feb. 8, 2016

(30) Foreign Application Priority Data
Aug. 9, 2013 (FR) 1357937

(51) Int. Cl. F24H 9/18; H05B 3/82; F24H 7/00; H05B 1/02

(52) U.S. Cl. CPC F24H 9/1818; H05B 1/0244; H05B 1/0202; H05B 3/82; F24H 7/002

(57) ABSTRACT

Water heater comprising a tank for holding water, the tank being delimited by a peripheral jacket and the wall of a leak-tight sheath immersed in the internal volume of the peripheral jacket, an electric heating device, characterised in that the heating device includes at least one inductor housed in the sheath and at least one load formed by at least a part of the wall of the sheath.

### FIELD OF THE INVENTION

The present invention relates to water heating appliances also referred to as water heaters. It particularly relates to an induction heating device of a water heater and a water heater equipped with such a device.

### TECHNOLOGICAL BACKGROUND

Water heaters are devices for heating water for various household or industrial needs. There are different types of water heater: the instant water heater and the water storage water heater.

The document WO2009/050631 relates to an instant water heater intended to heat water without storage thereof. The heating device used in this document forms a monolithic part with a sheath; said sheath forming a jacket serving to separate the inductive system from the water passing through the water heater. In this document, the major drawback is that, in the scenario where a problem relating to a malfunction of the heating device arises, it proves to be essential carry out the complete disassembly of the water heater in order to access the heating device, requiring prior removal of any presence of water from the water heater.

The present invention relates to a water storage water heater. The term water storage water heater denotes a water storage appliance which has at least one tank serving as a hot water storage heating body, also frequently referred to as a boiler. The water is admitted into the storage tank where it is intended to be heated therein. The capacity of such a tank is more or less great according to the requirements to which storage appliances are assigned, for example by being associated with one or more bathroom sink taps, a shower and/or a bath, etc.

The heating energies of a water heater are mostly gas, fuel oil or electricity. The present invention relates to electric water heaters. In a known manner, an electric water heater has a heating element immersed in the tank serving as a heating body for heating the water contained therein. This heating element is frequently a resistor, generally referred to as a “sheathed resistor”, having a modest size and having, due to the technology thereof, a particularly small exchange surface area with water. For this reason, the power of the sheathed resistor is not very high to prevent either the sheathed resistor from causing local boiling, or the sheathed resistor form becoming damaged in the scenario where, coated with scale, it no longer exchanges the energy thereof correctly with the water to be heated.

Limescale is practically present everywhere suspended in water and when the water contained in the tank serving as a heating body is heated, molecular agitation will induce the precipitation of the limescale or scaling on the sheathed resistor and generally on hot spots including the water heater pipes. Scaling is a major problem on water heaters because, according to the water characteristics, heating after heating, the heating element is coated with scale. This results, on one hand, in a reduction of the heat exchange with the water and, on the other, in a reduction of the service life of the heating element which overheats and ends up destroyed. The scale deposited reduces the transfer of heat to the water, the heating element overheats. If the heating element is heavily scaled, the heat transfer to the water becomes difficult and the water is not heated correctly given that, either the thermostat switches off the heating before the water heating setpoint temperature has been reached so as to protect the heating element which is liable to be damaged, or the thermostat does not detect the overheating of the heating element which continues heating and is then damaged.

To prevent such scaling, resistors inserted into sheaths exist. These resistors are known as steatite resistors from the name of the insulator supporting the resistive element. These resistors are then no longer in contact with water and are thus not coated with scale. However, this merely transfers the problem to the sheath, advantageously made of enamelled steel, which is immersed in the water and becomes indirectly the element heating the water being coated with scale. The problem is due to the heat transfer between the heating element comprising the resistors and the sheath. Indeed, the resistors require a progressive rise in heat and thus a significant time to transmit heat to the sheath promoting the deposition of scale onto the sheath.

Hence, water heaters with at least one heating element in the form of a resistor do not have very satisfactory thermal yields when they are scaled. Furthermore, these heating elements are only regulated by a thermostat and operate in on/off mode.

The present invention makes it possible to solve all or, at least, some of the drawbacks of current techniques. A problem underlying the present invention is that of proposing an electric water storage water heater that can operate at various powers, having a satisfactory yield while preventing or reducing scaling of the heating device of the water heater.

### SUMMARY OF THE INVENTION

To achieve this aim, the invention envisages a water heater comprising a tank for holding water, the tank being delimited by a peripheral jacket and the wall of a leak-tight sheath immersed in the internal volume of the peripheral jacket and an electric heating device, characterised in that the heating device includes at least one inductor housed in the sheath and at least one inductive load formed by at least a part of the wall of the sheath.

The technical effect, induced by the use of a sheath comprising at least one inductor, is that of generating currents induced directly in the sheath and thus promoting a more rapid heating effect.

Particularly advantageously, the device according to the present invention makes it possible to inspect, check, or even replace the heating device, without opening thus without having to drain the tank.

### BRIEF INTRODUCTION TO THE FIGURES

The aims, subject matter, and features and advantages of the invention will emerge more clearly from the detailed description of an embodiment thereof which is illustrated by the accompanying figures wherein:

FIG. 1 illustrates a cross-section of a water heater. The water heater comprises a tank intended to hold a volume of water and a heating device.

FIG. 2 illustrates a cross-section of a sheath wherein an inductor is situated and a cross-section of a secondary sheath wherein a temperature sensor is situated.

FIG. 3 illustrates a cross-section of the inside of the sheath wherein the coil is situated and a cross-section of the secondary sheath wherein a temperature sensor is situated.

FIG. 4 is a view of the supporting member, the supporting member comprising bearing surfaces at ends thereof.

FIG. 5 is a schematic representation of a bottom view of the supporting member at the induction coil connections.

The drawings are given by way of example and are not limiting in respect of the invention. They constitute schematic principle representations intended to facilitate the comprehension of the invention and are not necessarily to the scale of the practical applications.

### DETAILED DESCRIPTION

Before beginning a detailed review of embodiments of the invention, optional features which may optionally be used in association or alternatively are listed hereinafter:

The heating device comprises an inductor supporting member, the inductor including at least one coil portion formed on the supporting member, the supporting member being fixedly mounted in the sheath. Particularly advantageously, the peripheral jacket and the sheath define a closed volume.

The supporting member includes at least one spacer member configured to keep a space between the coil and the internal face of the wall of the sheath.

The supporting member includes a lateral external surface provided with a coil portion and a fixing portion, the coil portion being set back relative to the fixing portion, the fixing portion comprising a bearing surface on the internal face of the sheath, the offset of the coil portion relative to the fixing portion being greater than the thickness of the coil.

The space separating the coil and the internal face of the wall of the sheath is less than 5 millimetres, and preferentially less than 1 millimetre.

The bearing surface and the internal face of the wall of the sheath are arranged in a slide fit.

The bearing surface includes a plurality of apices of slots formed on an annular portion of the fixing portion.

The bearing surface includes two portions situated on either side of the coil portion along a longitudinal direction of the sheath.

A plurality of inductors are housed in the sheath. Advantageously, said plurality of inductors make it possible to heat specific areas of the water heater.

The sheath is electrically insulated from the tank. The sheath is mechanically connected to a plate; said plate also supporting the secondary sheath. The sheath, the secondary sheath and the supporting member are preferably enamelled together and screwed to the tank by means of bolts and a seal. For this reason, the sheath and the secondary sheath are electrically at the potential of the tank, generally earthed. It is advantageous not to connect this assembly to the earth and leave it at floating potential. Indeed, the induction coil has a developed surface facing the inside of the sheath and at a short distance, and thus forms an equivalent capacitor of several picofarads. This results in the sheath being charged in operation at a potential of several tens of volts at high impedance, i.e. without any hazard in terms of electrical safety. The application of this potential may, particularly advantageously, impede the precipitation of limestone to scale on the sheath. Finally, leaving the sheath at floating potential may simplify the compliance of the induction water heater with respect to electromagnetic interference rejection standards.

The heating device comprises a modular-power electronic generator controlled by an electronic control. A heating resistor is controlled in on/off mode and the fixed power thereof corresponds to an average user requirement. There is no possibility of increasing this power in the event of a need for additional hot water or reducing this power in the event of available energy limiting. Advantageously, the induction device incorporates an electronic generator suitable for adapting the power thereof according to the user's requirement. This requirement may be defined locally or read remotely. Indeed, the electronic generator may communicate simply with the environment thereof (home automation, smart meter, etc.), to reduce the power thereof at peak times, to increase the power thereof if needed, or to coincide the consumption to renewable energy production; energy wherein the production is difficult to predict. The latter dialogue is generally performed by the electricity meter suitable for providing real-time information on alternative energies available, or locally if the water heater power supply is connected directly to an alternative energy source.

The electronic generator adjusts the power of the heating means according to a local or remote setpoint.

The supporting member comprises a magnetic circuit. Advantageously, the supporting member can receive a magnetic circuit suitable for increasing the coupling with the load. In the event of the size of the induction system needing to be reduced, the magnetic circuit makes it possible advantageously to obtain an operating impedance of the induction system with a reduced number of turns and thus a reduced size.

The supporting member comprises a temperature sensor. Advantageously, the supporting member can receive a temperature sensor intended, according to the position thereof, either to protect the induction coil against overheating, or to read the temperature of the load.

The supporting member is hollow.

The tank comprises an opening, the water heater being configured such that the sheath can be inserted into the tank through said opening. The sheath is rigidly connected to a plate configured to be mounted on the opening of the tank such that the internal volume of the peripheral jacket is leak-tight; the plate engaging with the tank.

The wall of the supporting member is open-worked.

The sheath includes an opening for access to one of the ends thereof, the supporting member being inserted into the sheath via said end.

The tank comprises an opening, the water heater being configured such that the sheath can be inserted into the tank via said opening.

The supporting member is fixed relative to the sheath via one of the ends thereof situated on the side of the opening.

The wall of the sheath comprises at least one layer.

The sheath comprises a plurality of layers, at least one of the layers is configured to seal the inside of the sheath relative to the outside of the sheath, and at least one further layer of said plurality is configured to partially, and preferably entirely, form said load.

These layers advantageously make it possible to dissociate the sealing function from the load function for the induction system.

The wall of the sheath has a thickness less than 2 millimetres, preferably less than 1 millimetre.

The supporting member includes slits for holding the wire of the coil.

The sheath and the inductor have cylindrical shapes.

The sheath and the inductor have rectangular parallelepipedic shapes.

The tank has a capacity greater than 10 litres.

The invention also relates to an inductor supporting member holding a coil, the supporting member being suitable for engaging by insertion, with a slide fit, relative to the wall of a water heater sheath.

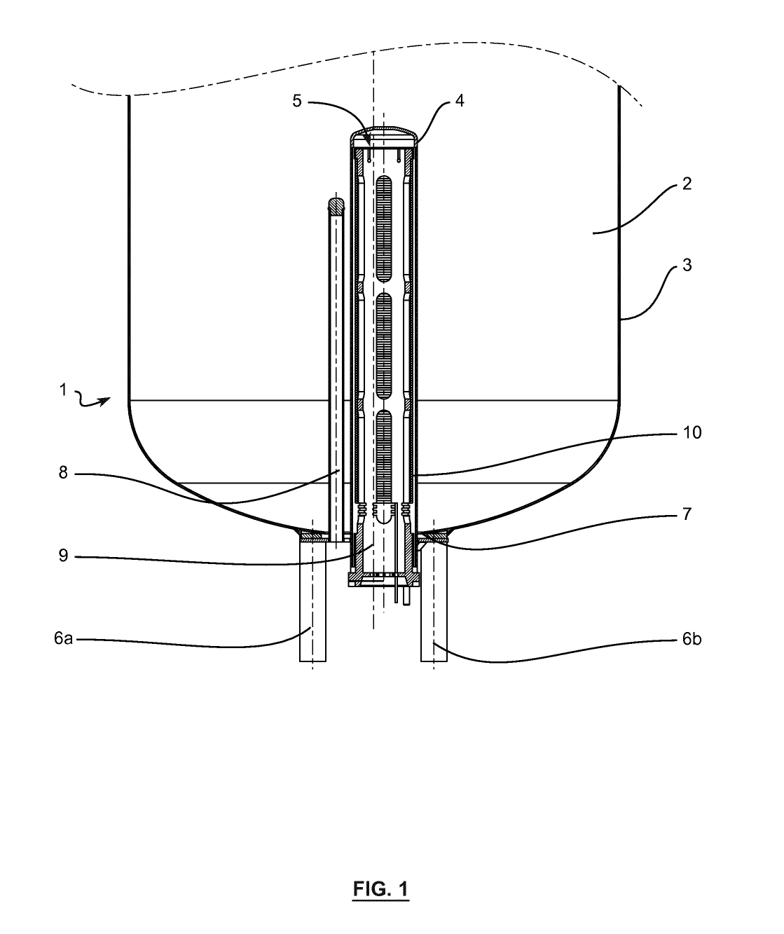

FIGS. 1 to 5 illustrate an example of a water heater comprising a tank and a heating device according to the present invention.

FIG. 1 illustrates a cross-section of a water heater 1. The water heater 1 comprises a tank 2 intended to store a volume of water and a heating device. The tank 2 has, for example, a capacity greater than 10 litres, preferably, greater than 20 litres. The tank 2 is delimited on one hand by a peripheral jacket 3 and, on the other, by the wall 4 of a leak-tight sheath 5 immersed in the internal volume of the peripheral jacket 3. Advantageously, said peripheral jacket 3 and said sheath (5) define a closed volume. The tank 2 comprises an opening 7 at one of the longitudinal ends thereof for inserting the heating device. The sheath 5 is advantageously inserted into the tank 2 via the opening 7. The tank 2 comprises at one of the longitudinal ends thereof two orifices: one inlet orifice 6a of water intended to be heated and one heated water outlet orifice 6b.

The heating device comprises at least one inductor 10 housed in the sheath 5 and at least one load formed by at least one portion of the wall 4 of the sheath 5. The inductor 10 is advantageously, indirectly, heat-generating. Induction requires a magnetic field generating an induced current and, thus, heating in a load. The inductor 10 is positioned on a supporting member 9. Particularly advantageously, the supporting member 9 simplifies the winding phase in that it serves both for the embodiment of the inductor 10 and also for holding same in the water heater 1. This makes it possible to avoid long and costly phases for solidifying the induction coil so as to ensure the mechanical cohesion thereof. The supporting member 9 is fixedly mounted in the sheath 5. Preferably, the supporting member 9 is fixed relative to the sheath 5 by only one of the ends thereof situated on the side of an opening 7; said opening 7 being situated via the peripheral jacket 3 of the water heater 1, at one of the longitudinal ends of the water heater 1.

Preferentially, the tank 2 and/or the sheath 5 and/or the inductor 10 have cylindrical shapes. According to a further embodiment, the sheath 5 and the inductor 10 have rectangular parallelepipedic shapes. In the latter case, the tank 2 adopts, particularly advantageously, a rectangular parallelepipedic shape so as to offer space-saving in use.

The water heater also comprises a secondary sheath 8 wherein a heat sensor is housed intended to monitor the temperature inside the tank 2. The secondary sheath 8 is preferentially a sheath of small diameter suitable for receiving a temperature sensor. It is necessary to ensure that the thermal contact between the secondary sheath 8 and the temperature probe positioned therein is correct. The secondary sheath 8 preferably has a cylindrical shape. It extends along the longitudinal direction of the sheath 5. The secondary sheath 8 is situated in the vicinity of the outer wall 4 of the sheath 5 and, for example, at less than 2 centimetres.

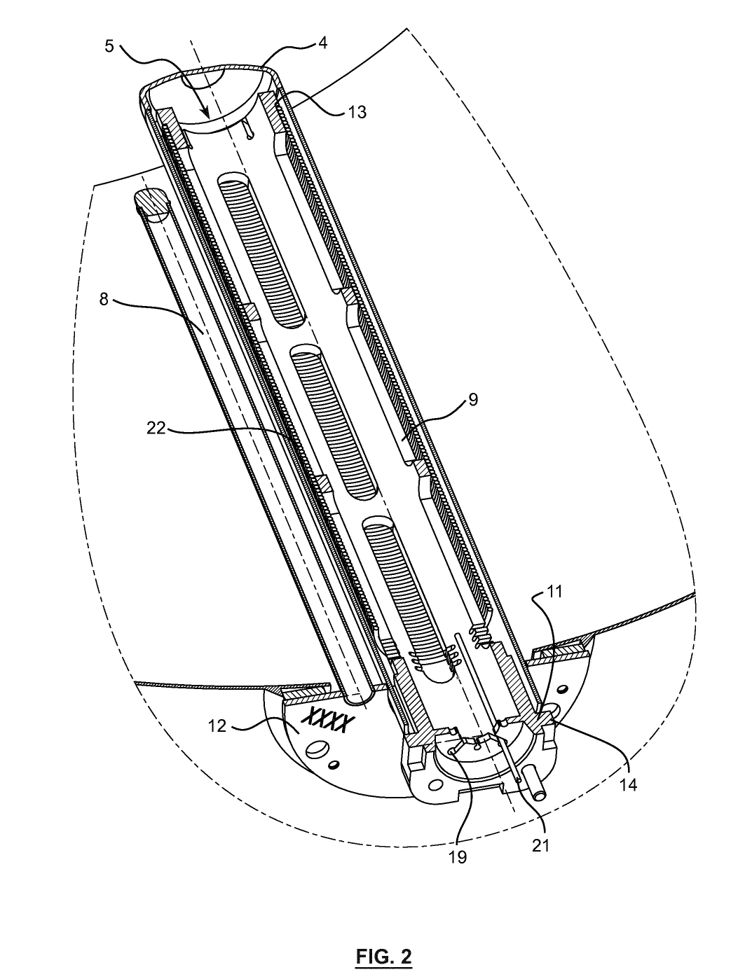

FIG. 2 illustrates a cross-section of the sheath 5 and the secondary sheath 8 receiving the temperature sensor. The wall 4 of the sheath 5 is leak-tight so as to prevent water from entering the heating device. The wall 4 of the sheath 5 has a thickness, preferably, between 0.4 millimetre (mm) and 2.3 millimetres. According to one preferential embodiment, the wall 4 of the sheath 5 is formed of a steel sheet. Advantageously, the sheath 5 is enamelled similar to the inside of the tank 2; the enamel adhering best on decarburised steel. Decarburised steel is very magnetic and thus proves to be a good load for an induction heating system. It should be noted that the heating power is dissipated in a thickness of approximately 0.4 mm (induction frequency of 20 kHz) in relation to the induction system and thus that it is necessary for the thickness of the sheath to be at least a thickness of 0.4 mm. The sheath 5 includes an opening for access to one of the ends thereof, the supporting member 9 being inserted into the sheath 5 via said end.

The sheath 5 is rigidly connected to a plate 12. The plate 12 engages with the tank 2 and is mounted on the tank 2 such that the internal volume of the peripheral jacket 3 is leak-tight. The secondary sheath 8 is preferentially attached by one of the longitudinal ends thereof to the plate 12 before being inserted into the tank 2. The secondary sheath 8 is a tube welded onto the same plate 12 as the sheath 5 and is enamelled like said sheath 5. The plate 12 herein has the shape of a disk. The plate 12 is attached to the outer wall of the tank 2 via a seal and attachment means. Advantageously, the sheath 5 comprises a base 11 attached to one of the longitudinal ends thereof. The base 11 is preferably in the shape of a disk or a square.

Particularly advantageously, the plate 12 comprising the sheath 5 and the secondary sheath 8 can be removed from the water heater 1 by merely removing the attachment means. Exceptionally, the heating device can be inspected, checked, or even replaced without opening thus without having to drain the tank 2.

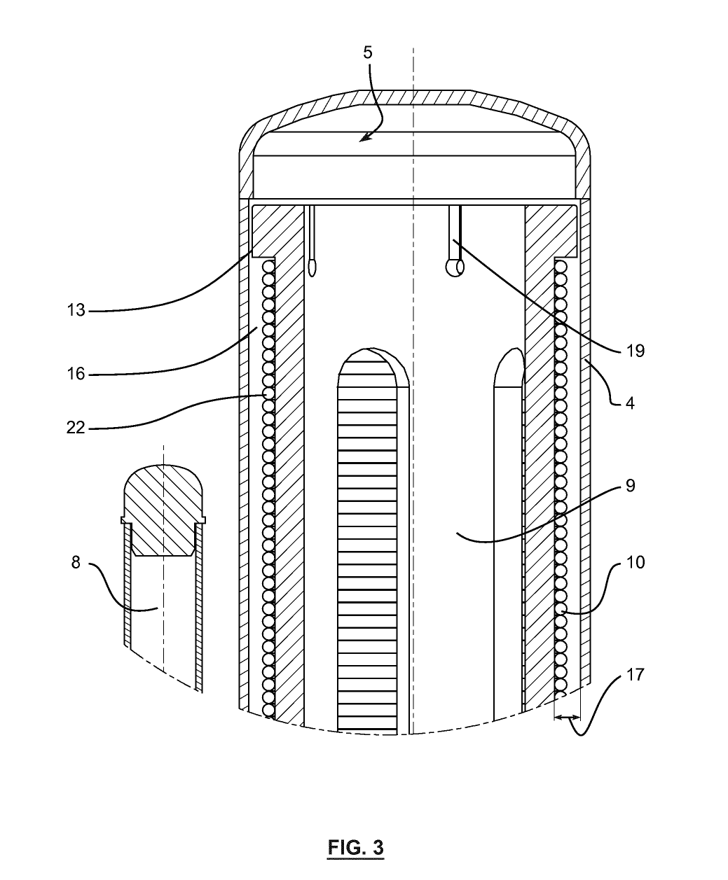

FIG. 3 illustrates a cross-section of the inside of the sheath 5. The inductor 10 includes a coil 22 formed on the supporting member 9. The supporting member 9 includes a lateral outer surface provided with a coil portion 15 and a fixing portion. The coil portion 15 is set back relative to the fixing portion. The fixing portion comprises a bearing surface 13, 14 on the internal face of the sheath 5. The bearing surface 13, 14 includes two portions situated on either side of the coil portion 22 along a longitudinal direction of the sheath 5. The offset 17 of the coil portion 15 relative to the fixing portion is greater than the thickness of the coil 22. The space 16 separating the coil 22 and the internal face of the wall 4 of the sheath 5 is, preferably, less than 2 millimetres and, advantageously, less than 1 millimetre. Surprisingly, it is advantageous for the inductor 10 to be placed in the vicinity of the sheath 5. This favours a concentration of the heating on only one portion of the thickness of the sheath 5. It should be noted that, surprisingly, a person skilled in the art tends to separate induction type coils from the heated elements. Indeed, as their name suggests, the heated elements heat and tend to induce the heating of the induction systems if they are positioned too close. However, the induction coils 22 are generally insulated with organic varnishes, the most effective whereof cannot withstand temperatures greater than 220° C. In the present invention, heating is advantageously applied to the internal wall 4 (of a thickness for example of 0.4 mm) of the sleeve 5 which is heated. However, the sheath 5 is immersed in the water with which it exchanges the heat thereof. During the heating phase, the temperature of the sheath 5 is thus always greater than the temperature of the water for heat exchange to take place, but the difference in temperature remains small, for example 30° C. for an injected power of 1800 Watts (W). For this reason, if the maximum temperature of the water to be heated is 65° C., the sheath 5 attains a maximum of 95° C. and the sheath 5 can then be considered to be a cold zone for the induction coil 22. It is then advantageous to move the induction coil 22 closer to the sheath 5 so as to cool same. This moving closer together is also advantageous for the design thereof as the coupling with the load is then increased and therefore the induction system 10 needs less ampere-turns in order to function correctly with the associated inverter thereof, which increases the yield of the whole and thus lowers the cost. Finally, it should be noted that it may be necessary to insert an additional electrical insulator around the coil 22 in the event of the distance, between the coil 22 and earthed sheath 5, becoming small.

The bearing surface 13 and the internal face of the sheath 5 are arranged in a slide fit. Particularly advantageously, during the insertion of the supporting member 9 into the sheath 5 and in use, the bearing surface 13 prevents the coil from coming into contact with the internal face of the wall 4 of the sheath 5. Advantageously, the diameter of the bearing surface 13 greater than the diameter of the coil portion 15, makes it possible, on one hand, to protect the coil 22 and, on the other, control the insertion play of the supporting member 9 comprising the coil 22 in the sheath 5.

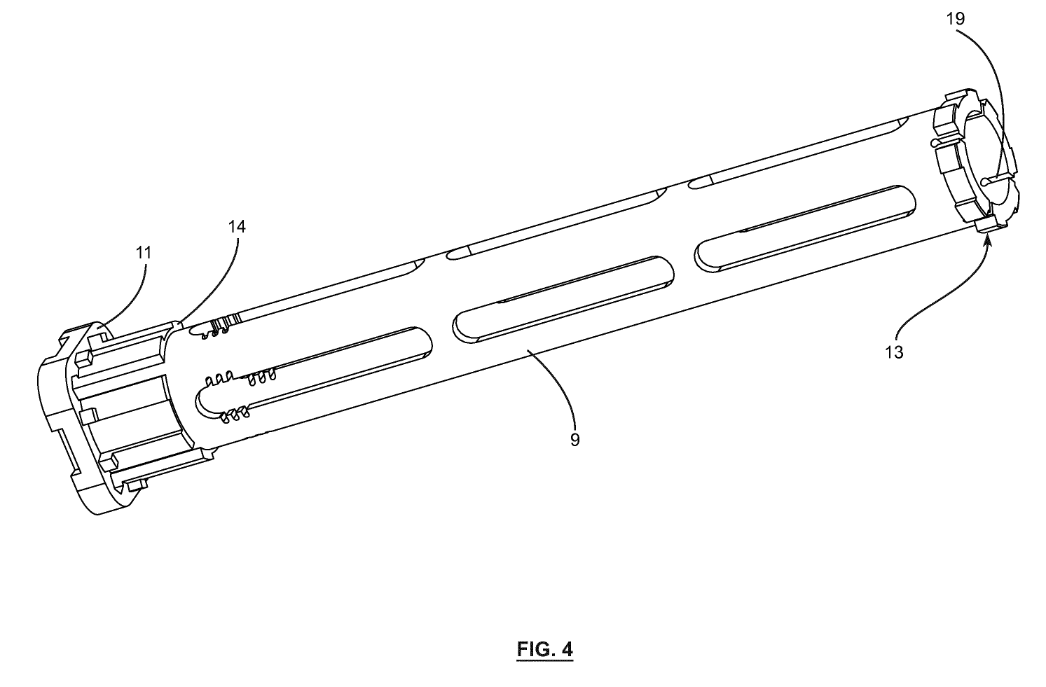

FIG. 4 illustrates a view of the supporting member 9. The supporting member 9 is preferentially presented in the form of a hollow tube. Particularly advantageously, the supporting member 9 is configured so as to engage with the shape of the internal wall 4 of the sheath 5. A first longitudinal end of the supporting member 9 comprises a first fixing portion including a base 11, a bearing surface 13, 14 and at least one slit 19 for holding the coil 22 wire. A second longitudinal end of the supporting member 9, opposite the first, comprises a bearing surface 13, 14 and at least one slit 19, 20 for holding the coil 22 wire. The bearing surface 13, 14 includes, particularly advantageously, a plurality of apices of slots formed on an annual portion of the fixing portion. Preferentially, the slots help balance the supporting member 9 inside the sheath 5. They also limit hyperstatic phenomena during insertion. The slots advantageously make it possible to simplify the coil 22. According to one embodiment where the sheath 5 has a rectangular parallelepipedic shape, a Pan Cake type induction coil 22 will preferably be used, without having to use a supporting member 9.

Advantageously, the wall of the supporting member 9 is open-worked so as to promote heat transfer within the sheath 5, minimise the weight of the supporting member 9 and thus the cost thereof. Preferably, the supporting member 9 is formed from materials resistant to high temperatures such as plastics (for example, BMC “Bulk Moulding Compound” comprising Polyester resin or Vinylester) reinforced with glass fibres. In position, the supporting member 9 extends along the longitudinal direction of the sheath 5. The supporting member 9 is advantageously hollow and the centre thereof may allow the passage of the coil 22 wire 21.

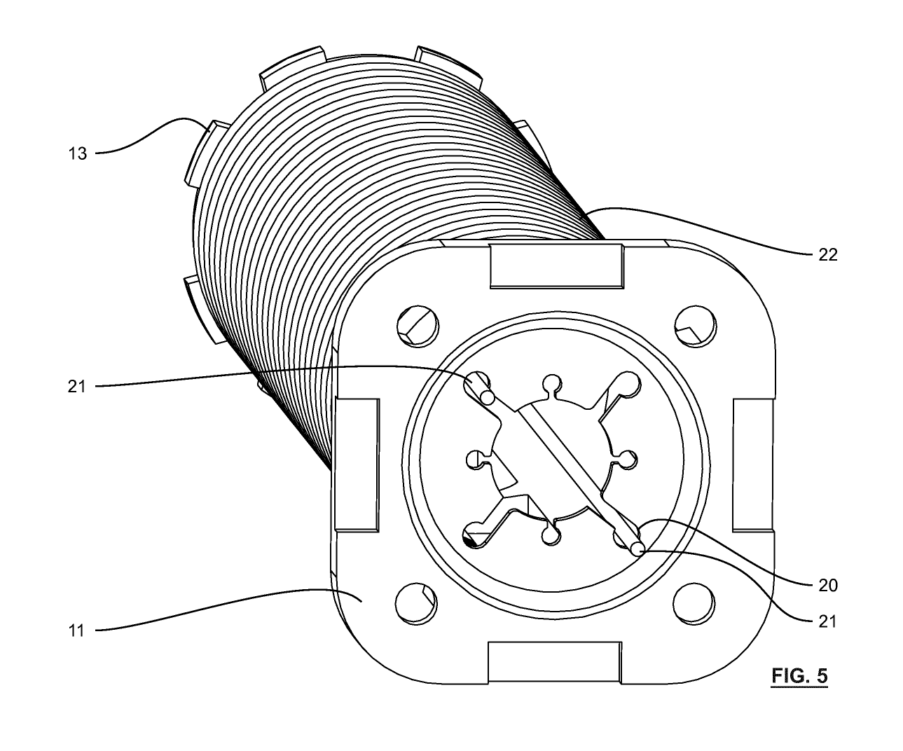

FIG. 5 is a schematic representation of a bottom perspective view of the supporting member 9. The coil 22 extends along the longitudinal direction of the sheath 5 such that the heating is performed homogeneously and uniformly along the internal wall 4 of the sheath 5.

The supporting member 9 serves as a supporting member for the coil 22. In order to “coil”, the coil 22 wire 21 is inserted inside the supporting member 9 and crimped at the end of the base 11. The wire 21 is then stretched and passed through a slot of the bearing surface 13 situated at one of the ends of the supporting member 9. The supporting member 9 can then be attached on the winder (similar to a turning machine) and the coil 22 wire 21 which is inserted via the slot of the bearing surface 13 of the supporting member 9 is then immediately located in the correct position to start winding. At the end of winding, the wire is cut and inserted through securing slits 20 or notches until the bearing surface 14 situated at the other end of the supporting member 9 is reached. Advantageously, the supporting member 9 comprises a plurality of slits 20 as different inductor versions according to the power requirement are envisaged. The notches or slits 20 serve to lock the coil 22 wire 21 which is then reinserted in the centre of the supporting member 9 to join the outgoing wire 21, but diametrically opposed. The two wires 21 are connected to the respective connectors thereof rigidly connected to the base 11.

Advantageously, the coil 22 wire 21 is wound around the supporting member 9 from a first bearing surface portion 13, 14, situated at a first end of the supporting member 9 to a second bearing surface portion 13, 14 situated at a second end of the supporting member 9. The coil 22 is advantageously held, on either side of the supporting member 9, by the slits 19, 20 arranged at the longitudinal ends of the supporting member 9. The coil 22 wire 21 is configured such that, following the winding of the wire 21 around the supporting member 9, the two ends of the wire 21 pass through the slits 20 situated on the base 11 and joined to the end of the supporting member 9 whereon the base 11 is attached. The input and output of the coil 22 are connected in a diametrically opposed manner. The two ends of the coil 22 wire 21 will be preferentially connected to the power supply input and output terminals so as to enable the operation of the inductor 10 housed in the sheath 5. Preferentially, by means of the slits 20, the coil 22 is formed from a standard wire which does not need to be equipped with a thermo-adhesive overlay; the securing of the coil 22 being advantageously only mechanical on the supporting member 9. According to one example of an embodiment, the coil 22 is configured such that the coil has an impedance of resistance 1.8 Ohm and inductance 50 μH, for a frequency of 20 kHz. The coil 22 is then, for example, embodied by 16 copper strands of 0.4 mm in diameter wound in Litz wire, suitable for forming a coil having an outer diameter 46 mm, for a length of 270 mm and a weight of 350 g. The coil formed is then connected to a half-bridge type resonant inverter, for example. It should be noted that, on the same principle, the induction system can be optimised to work with different generator schemes including simpler generators referred to as “mono-switches”, for example, which could be used for some power ranges.

According to one preferential embodiment, the sheath 5 comprises a plurality of inductors 10 positioned on the same supporting member 9, at different heights. Advantageously, dissociating a plurality of inductors 10 makes it possible to selectively heat the water of the tank 2 of the water heater 1. According to a first embodiment, it may be chosen to heat all the water of the tank 2. According to a further embodiment, it would be chosen to heat only the water situated in the upper part, or a defined water volume corresponding to a position of the induction system in the tank 2. This principle is based on the stratification effect, i.e. the formation of more or less hot layers of water on moving towards the top of the water heater 1. The benefit is that of being able to optimise the production of hot water by drawing the hot water in the top of the tank 2 while allowing the arrival of cold water into the bottom of the tank 2. In this way, more hot water is obtained than if the hot water and the cold water were mixed in the tank 2. According to one preferential embodiment, the sheath 5 is configured so as to have the same height as the height of the tank, along a vertical direction when the device is in position.

According to a further embodiment, the induction system 10 is removable in the sheath 5 so as to be suitable for being positioned at the top, centre or bottom, or at all the intermediate positions of the tank 2. In the scenario wherein the inductor 1 is positioned in the bottom of the tank 2, the entire tank 2 is heated. In the scenario where the inductor is positioned at the centre of the tank 2, then essentially half of the tank 2 is heated, paying particular attention to the stratification. In the scenario where the inductor is positioned at the top of the tank 2, only a reduced part of the tank 2 is heated. Preferably, the sheath 5 comprises 3 inductors situated respectively in the upper part, in the central part and in the lower part of the sheath 5, so as to simultaneously or alternatively heat different zones of water in the tank 2. This could allow some modularity in respect of hot water volume. The movement of the inductor may be physical, manual or motorised, or a plurality of inductors could be envisaged and powered as needed.

According to one embodiment, the wall 4 of the sheath 5 includes two layers: a first layer inert to the magnetic field creating the leak-tightness and a second layer enabling heating by induction. The magnetic field has no effect on non-magnetic and non-conductive materials such as plastic, composite insulators, glass, ceramics. It would thus be possible to envisage a first layer of the wall 4 of the sheath 5 acting as a seal inside which the induction system 10 would be housed; said first layer of the wall 4 of the sheath 5 would be made of non-magnetic and non-conductive materials. A second layer, preferably having a cylindrical shape, could be positioned around the first layer and would serve as a load for the induction system. The benefit would be that this load (i.e. the second layer of the wall 4 of the sheath 5) would be immersed and thus that it would exchange the temperature thereof on the two opposite faces thereof. This load could advantageously be movable which could mechanically aid descaling. This load no longer having the constraint of withstanding the pressure could be made of a thinner material, greater than the skin thickness at 20 kHz, i.e. a minimum thickness of 0.5 mm. According to one embodiment, this load could be made of materials with a low Curie point so as to naturally limit the heating thereof. It would be advantageously possible to transfer inductive energy into the tank 2, in a fully secure manner as it is galvanically isolated. A part of the inductor 10 could be placed in the sheath 5 to heat a cylindrical load opposite, placed in the tank 2, and retain a part of the coil 22 so as to be able to couple a coil positioned in the tank 2, which could serve to power an immersed device optionally, for example, relating to anti-corrosion or anti-limescale devices, or any electronic devices.

The present invention is not limited to the embodiments described above but extends to any embodiment covered by the claims.

### REFERENCES

1. Water heater
2. Tank
3. Peripheral jacket
4. Sheath wall
5. Sheath
6a, 6b. Orifice
7. Opening
8. Secondary sheath
9. Supporting member
10. Inductor
11. Base
12. Plate
13, 14. Bearing surface
15. Coil portion
16. Space
17. Offset
19, 20. Slit
21. Wire
22. Coil

1. A water heater comprising:
a tank for storing water, the tank being delimited by a peripheral jacket and a wall of a leak-tight sheath immersed in an internal volume of the peripheral jacket, said peripheral jacket and said sheath defining a closed volume;
an electric heating device,
wherein the heating device includes:
at least one inductor housed in the sheath and at least one inductive load formed by at least a part of the wall of the sheath, said inductor being configured to generate an induced current and heating in the load;
an inductor supporting member, the inductor including at least one coil portion formed on the supporting member, the supporting member being fixedly mounted in the sheath;
and wherein the sheath includes an opening for access to one of the ends thereof, the supporting member being inserted into the sheath via said end.

2. The water heater according to claim 1 wherein the supporting member includes at least one spacer member configured to keep a space between a coil and an internal face of the wall of the sheath.

3. The water heater according to claim 2 wherein the space separating the coil and the internal face of the wall of the sheath is less than 5 millimetres, and preferentially less than 1 millimetre.

4. The water heater according to any one of the two claim 1 wherein the supporting member includes a lateral external surface provided with a coil portion and a fixing portion, the coil portion being set back relative to the fixing portion, the fixing portion comprising a bearing surface on an internal face of the sheath, the offset of the coil portion relative to the fixing portion being greater than the thickness of the coil.

5. The water heater according to claim 4 wherein the bearing surface and the internal face of the wall of the sheath are arranged in a slide fit.

6. The water heater according to claim 4 wherein the bearing surface includes a plurality of apices of slots formed on an annular portion of the fixing portion.

7. The water heater according to claim 4 wherein the bearing surface includes two portions situated on either side of the coil portion along a longitudinal direction of the sheath.

8. The water heater according to claim 1 wherein a plurality of inductors are housed in the sheath.

9. The water heater according to claim 1 wherein the supporting member comprises a magnetic circuit.

10. The water heater according to claim 1 wherein the supporting member comprises a temperature sensor.

11. The water heater according to claim 1 wherein the supporting member is hollow.

12. The water heater according to claim 1 wherein the wall of the supporting member is open-worked.

13. The water heater according to claim 1 wherein the tank comprises an opening, the water heater being configured such that the sheath can be inserted into the tank through said opening.

14. The water heater according to claim 13 wherein the supporting member is fixed relative to the sheath via one of the ends thereof situated on the side of the opening.

15. The water heater according to claim 1 wherein the wall of the sheath comprises at least one layer.

16. The water heater according to any one of the claim 1 wherein the sheath comprises a plurality of layers, at least one of the layers is configured to seal the inside of the sheath relative to the outside of the sheath, and at least one further layer of said plurality is configured to partially, and preferably entirely, form said load.

17. The water heater according to claim 1 wherein the sheath is electrically insulated from the tank.

18. The water heater according to claim 1 wherein the heating device comprises a modular-power electronic generator.

19. The water heater according to claim 18 configured such that the electronic generator adjusts the power of heating means according to a local or remote setpoint.

20. The water heater according to claim 1 wherein the wall of the sheath has a thickness less than 2 millimetres, preferably less than 1 millimetre.

21. The water heater according to claim 1 wherein the supporting member includes slits for holding the wire of the coil.

22. The water heater according to claim 1 wherein the sheath and the inductor have cylindrical shapes.

23. The water heater according claim 1 wherein the sheath and the inductor have rectangular parallelepipedic shapes.

24. The water heater according to claim 1 wherein the tank has a capacity greater than 10 litres.
